(19) United States
(12) Patent Application Publication
(10) Pub. No.: US 2011/0254383 A1
(43) Pub. Date: Oct. 20, 2011

(54) SMART MODULE AND METHOD WITH MINIMAL STANDBY LOSS

(75) Inventors: Roger L. Franz, Mundelein, IL (US); Mark F. Valentine, Kenosha, WI (US)

(73) Assignee: MOTOROLA, INC., Schaumburg, IL (US)

(21) Appl. No.: 12/761,441

(22) Filed: Apr. 16, 2010

(51) Int. Cl. H02J 1/00

(52) U.S. Cl. 307/131

(57) ABSTRACT

A smart method (100) and module (300) to minimize standby loss is disclosed. The method (100) can include the steps of: detecting (110) a current parameter at a load node; determining (120) whether a current parameter threshold has been reached; and disabling (13) power delivery based on determining whether the current parameter threshold has been reached. Advantageously, the smart method (100) can provide minimal to zero standby loss, when a current parameter threshold has been reached. This method has use in many electronic devices and particularly in battery chargers, for example, when a predetermined current parameter threshold has been reached or an energy storage device (battery) charge is complete, minimal or zero standby loss can be attained. In one embodiment, the smart method (100) can substantially fully switch off AC mains to eliminate standby loss.

### BACKGROUND

1. Field

The present disclosure is directed to a smart module and method with minimal standby loss.

2. Introduction

While some incremental improvements in switching supplies have reduced standby power consumption of power supplies, known rapid chargers still draw power at about 100 mW. This problem impacts all consumer electronics devices that typically never fully turn off even when switched off. Over time, in many such devices, wasted energy can be significant.

Labels like Energy Star have partially addressed the issue, but these labels continue to be awarded for reduced standby losses. Other methods known to the inventors, require keeping at least some standby power active at all times, so that the circuit can wake up. This does not resolve the problems, since over time and operation of many such devices globally, they can result in significant wasted power.

Thus, there is a need for smart devices, modules and methods with minimal or zero standby loss, that can substantially fully switch off AC mains when a current parameter threshold has been reached. This can be useful in electronic devices and battery chargers, for example, when charged complete or a predetermined current parameter threshold has been reached, to minimize or eliminate standby loss.

There is also a need to provide a visual and/or tactile indication to a user that power has been turned off, so the user can then reset the power supply on demand, as desired.

There is further a need to provide a zero or near zero standby power solution with “area topographical morphing”, where a smart module with topographical morphing can be used for mode indication which are intuitive to a user, user friendly and ergonomic.

There is also a need to provide a zero or near zero standby power solution, to minimize or eliminate unnecessary power drain when an electronic device is at idle, asleep, or a battery has been fully charged in a charger, for example.

There is yet further a need for a smart module that is electrically and mechanically robust, such as with robust contacts rated for switching AC mains of a power supply, such that, for example, when charge is complete or a certain current parameter threshold is reached, an indicator flag or button visually indicates power has been completely turned off to provide a zero standby power. As desired, a user could unplug the system or reactivate it for a subsequent cycle or charging cycle, or other use in connection with an electronic device.

Thus, there is a need for energy reduction during standby, idle or off mode in connection with electronic devices, by utilizing smart switching.

Accordingly, there is a need to solve many of the above problems and shortcomings in the field, to minimize or eliminate unnecessary power drain.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a smart method with minimal standby loss, according to one embodiment.

FIG. 2 is an exemplary graph 200 with time shown on an x axis and a DC current on a y axis, illustrating how a current parameter threshold has been reached, by for example, (i) detecting a threshold 210 DC current value or (ii) detecting a rate of change 220 of a DC current value over time, in connection with the smart method in FIG. 1, according to one embodiment.

FIG. 3 is a simplified exemplary front view illustrating an actuator 310, in four different potential states, of the smart module 300 and method, with an actuator button 370 and an explanatory table, according to one embodiment.

FIG. 4 is an exemplary simplified block diagram of a smart module 300, according to one embodiment.

FIG. 5 is an exemplary plan view of a smart module, in the form of a battery charger, for use in charging an energy storage device in an electronic device or a wireless communication device, via a connector, according to one embodiment.

FIG. 6 is an exemplary plan view of a smart module, shown connected to a battery charger, according to one embodiment.

FIG. 7 is an exemplary simplified block diagram of a product with electronics with an internal smart module 300, according to one embodiment.

### DETAILED DESCRIPTION

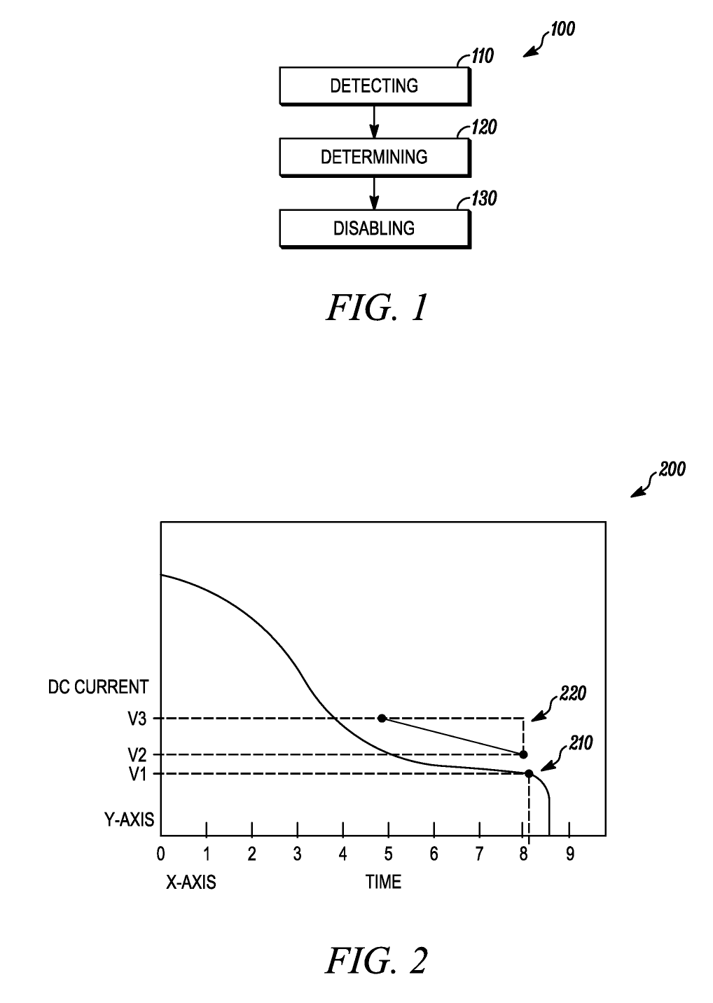

FIG. 1 is an exemplary block diagram of a system or method to minimize standby loss 100, according to one embodiment. The method 100 can include the steps of: detecting 110 a current parameter at a load node; determining 120 whether a current parameter threshold has been reached; and disabling 130 power delivery based on determining whether the current parameter threshold has been reached. Advantageously, Applicant's smart method can provide minimal to zero standby loss, when a current parameter threshold has been reached. This can be useful in many electronic devices and particularly in battery chargers, for example, when a predetermined current parameter threshold has been reached or an energy storage device (battery) charge is complete, to minimize or eliminate standby loss. In one embodiment, the smart method can substantially fully switch off AC mains to eliminate standby loss, as detailed below.

In one embodiment, the detecting step 110 can include at least one of periodically detecting a DC current value and periodically detecting a rate of change of a DC current value over time. Referring to FIG. 2, an exemplary graph 200 with time shown on an x axis and a DC current on a y axis, is shown. The graph 200 illustrates how a current parameter threshold has been reached, by for example, (i) detecting a threshold 210 DC current value or (ii) detecting a rate of change 220 of a DC current value over time, in connection with the smart method in FIG. 1, according to one embodiment.

In a first preferred embodiment, when the detecting step includes periodically detecting a DC current value, the current parameter threshold is set at a predetermined DC current set-point, shown as item 210 at time 8 in FIG. 2. This is a simple yet reliable step, where the method and associated circuitry is designed for a specific load having known characteristics. When the load node current reaches a set threshold level, the described functions and steps, as detailed herein, are set in motion.

In a second preferred embodiment, when the detecting step includes periodically detecting a DC current value over time, the current parameter threshold is set at a predetermined rate of change of the DC current value over a certain time, shown as item 220. Stated differently, the set point or trip point can be established by a rate of change of the DC current value over a certain time, as shown in FIG. 2. Some batteries and other loads are sensitive to rate of charging, which may be defined as change in current over time. In one such embodiment, several periodic measurements are made over time, such as times 1-9 in FIG. 2, and stored in a suitable control circuitry, as detailed below. As is customary in the art, a change or variation in current (y-axis) divided by change or variation in time (x-axis) is denoted by the delta (Δ) terms as shown in FIG. 2. This variation may be of benefit to provide for compatibility with electronic devices and batteries having embedded memory chips or other features to prevent incompatibility, misuse, or minimize safety concerns.

In more detail, processing of data for current measurement and threshold actions can be performed by processors. Thus it can be seen that any number of rate of change parameters, for example, but not limited to, linear, logarithmic, etc. may be used to provide the desired type of control for any specific power supply and load node configuration. These rate of change parameters may be designed into appropriate circuit elements, coded into a fixed memory element, or may be loaded into the module by means of software commands.

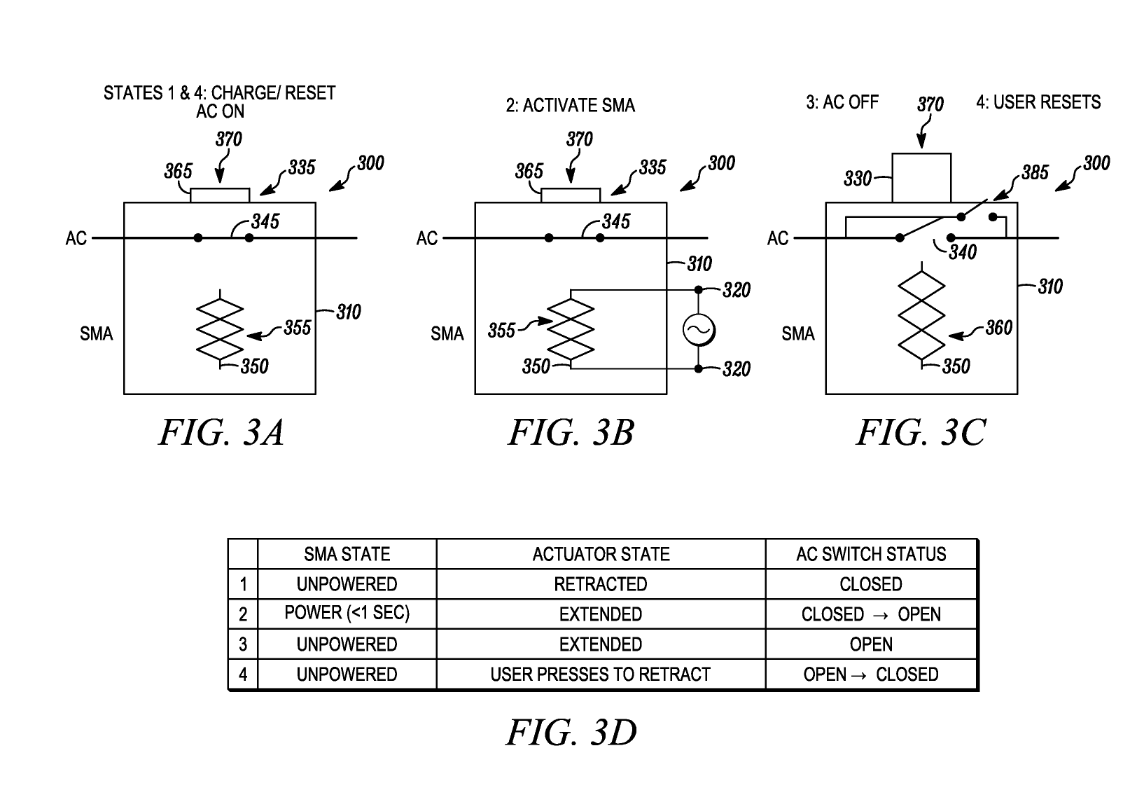

The method 100 can further include providing an indicating component for visually indicating power delivery is disabled and that the current parameter threshold has been reached. Referring to FIG. 3, a simplified exemplary front view of a smart module showing an indicating component is shown. Advantageously, the indicating component can provide a visual and tactile indication to a user that power has been turned off. Subsequently, the user can then reset the power supply on demand as desired. In a preferred embodiment, “area topographical morphing” can be utilized in the smart method 100. Advantageously, topographical morphing can visibly provide a mode or state indication, which is intuitive to a user, user friendly and ergonomic, as will be discussed in more detail herein.

In one embodiment, the method 100 can provide a bypass switch configured to over ride certain operations of the method, as shown in FIG. 3, when a user desires to keep the electronic device on. For example, in one user case, a user could desire to have a wireless communication device, such as a cell phone, with a fully charged battery when needed, upon returning from being out of town after a couple of days.

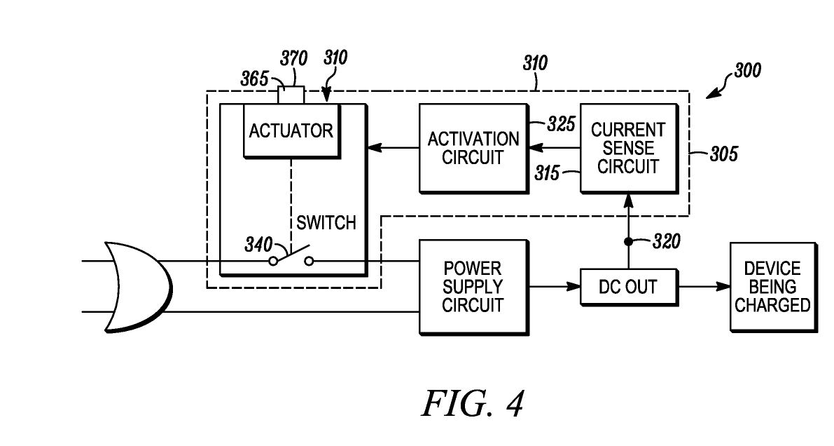

In a preferred embodiment or user case, the load node is coupled to an energy storage device. By way of example, the energy storage device can be battery, such as Lithium Ion, Nickel Metal Hydride, etc., as detailed in FIG. 4. Advantageously, this can provide minimal or zero standby losses, when the energy storage device is charged.

As should be understood by those skilled in the art, the smart method has application in other conventional electronic devices, standalone device and appliances, as detailed herein. In this variation, rather than to detect the status of battery charging, current measurement at a load node can be utilized, to sense the status of the device or appliance itself, with Applicant's steps and structure to actuate and shut off the incoming power source. By way of example, the smart method and module herein finds application in cellular telephone handsets, radios, music players, televisions, games, electrical appliances, computers, computer accessories, video recorders, cable TV set top boxes and the like.

In a preferred embodiment, the smart method 100, at least one of the detecting 110, determining 120 and disabling steps 130 is enabled by use of a processor or integrated circuit. Advantageously, such a processor could be simple and robust in design and could be made cost effectively. In more detail, the smart method and module can be configured so as to communicate through a standard bus, for example, Universal Serial Bus (USB), or any other communications protocol, such that threshold settings and the like could be actively changed or adjusted as desired, via software commands.

In a preferred user case, the smart method 100 steps of detecting 110, determining 120 and disabling 130, define a battery charger with substantially zero standby loss once the current parameter threshold has been reached.

Referring to FIGS. 3 and 4, a smart module 300 to minimize standby loss is shown. It can include: an enclosure 305; an actuator 310; and a current sensing circuit 315 configured to detect a current parameter at a load node 320, determine whether a current parameter threshold has been reached and disable power delivery based on determining whether the current parameter threshold has been reached, by de-actuating the actuator 310. Advantageously, when current parameter threshold has been reached, power delivery can be disabled, thereby providing a zero standby power draw, until reset. In a preferred embodiment, the smart module 300 is small, narrow in profile, portable and structurally robust, and can be made as a stand alone device or made as a component to a product, such as an electronic product, charger, appliance and the like.

As shown in FIG. 4, the current sensing circuit 315 can include an activation circuit 325 connected to the actuator 310 to provide a signal to de-actuate the actuator 310, shown as in a de-actuated mode 330 with a switch open 340 in FIG. 4. An actuated mode 335 with a switch closed 345 is shown in FIG. 3

In a preferred embodiment, as best shown in FIG. 3, the actuator 310 can include a shape memory alloy (SMA) configured to change shape through Joule heating. In more detail, shape memory alloys beneficially can provide conductors 350 or wires, typically comprising nickel titanium alloys, which are caused to change shape upon Joule heating, for example, when the conductor 350 is heated for a short period of time through the passage of current through it. The current is available from the power source prior to the power source being fully switched off. Upon cooling again, the conductor may return to its original shape and the cycle can be repeated. The conductor 350 in FIG. 3 includes a heated mode 355 throwing switch open 340 and a cool mode 360 with switch closed 345.

As should be understood, other potential actuators 310 can include and are not limited to: dissimilar metal (bilayer) mechanisms wherein two metals may contract differentially upon heating and produce a bending effect; electromagnetic mechanisms such that movement may be achieved through action of an electromagnet upon a magnetically soft material, such as solenoids, relays, or motors; electrostatic mechanisms wherein voltage may be used to cause repulsion of like charges, resulting in separation and movement of one element relative to another; piezoelectric mechanisms wherein application of a voltage to materials having piezoelectric properties may produce small displacements which can be amplified mechanically or through means such as a screw drive; electroactive polymer mechanisms wherein materials are known that constrict with the application of external voltage; microelectromechanical system (MEMS) devices such that miniature devices are typically fabricated on silicon may use electrostatic or electromechanical means to produce motion and any combination of the above.

As shown in FIGS. 3 and 4, the enclosure 305 has an opening 365 for receiving the actuator 370, the actuator preferably comprising a button including a retracted position 375 configured to enable the current sensing circuit 315 and an extended position 380 arranged to visually indicate that power delivery is disabled (or that the current parameter threshold has been previously reached). Advantageously, the user intuitively understands that operation has been, and the button is located and positioned to be visible from a distance, thus a user can easily see the state of the smart module 300.

In a preferred embodiment as shown in FIG. 3, a bypass switch 385 can be utilized and configured to over ride certain operations of the smart module, as detailed earlier. As an alternative to having a discrete bypass switch, defeating of the full off functionality may be effected through an external data transfer communication means, for example, from a “smart phone.” For example, if the load node is connected to a load such as a set top box, the service provider may desire to maintain the unit active for updates or downloads, and in this case would be able to defeat the full off functionality, as appropriate. When certain priority service updates are completed, a command may be sent to reactivate the automatic full off functionality until such time as the user wishes to use the unit again and resets it, as described herein.

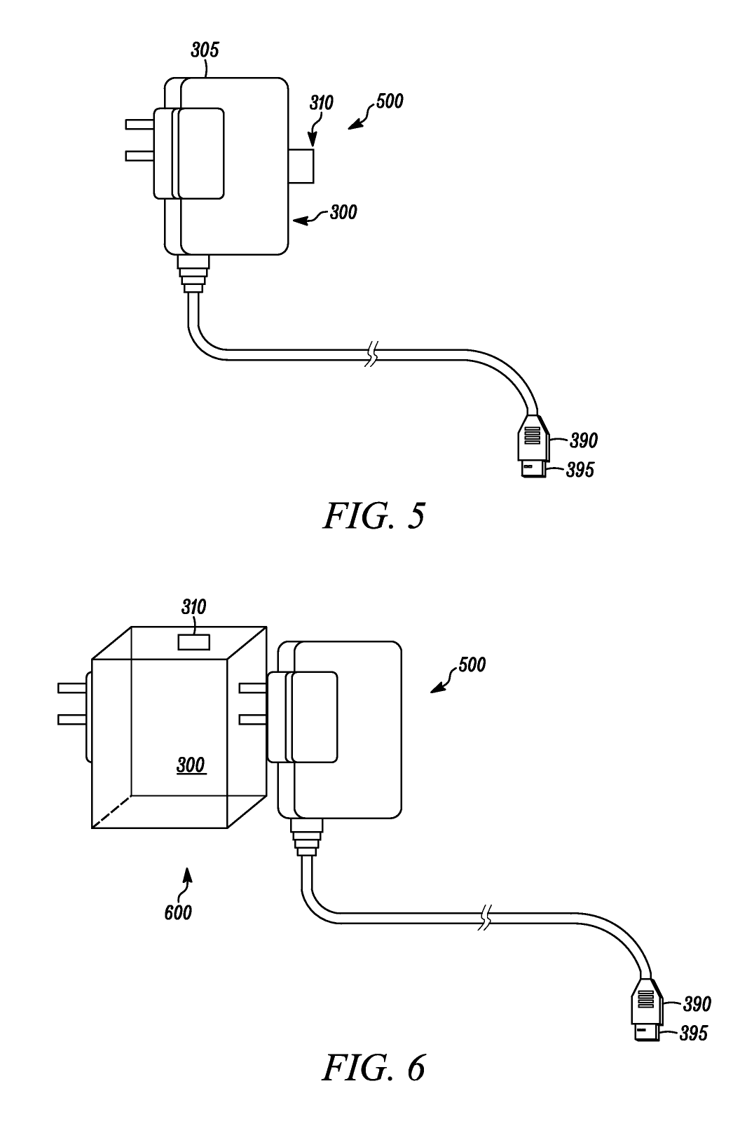

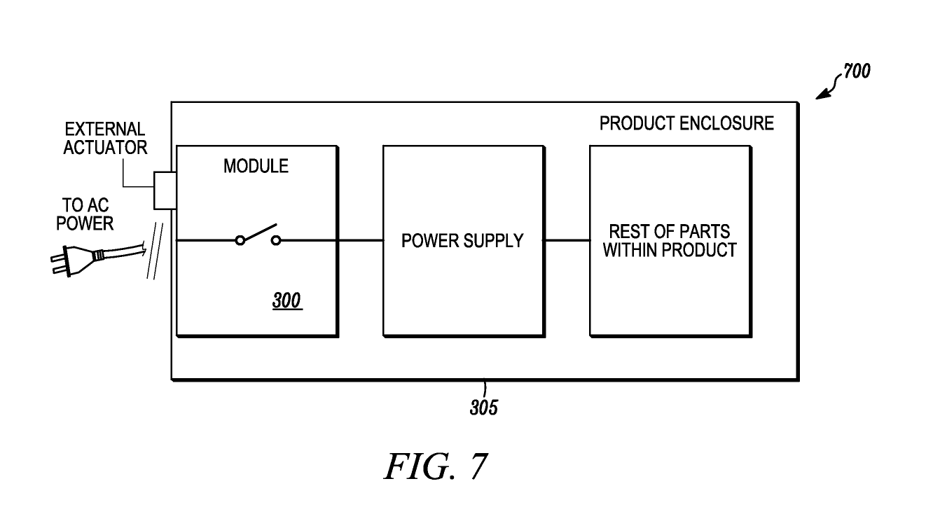

As detailed previously, the load node 320 can be configured to be coupled to at least one of an electronic device, a wireless communication device and an energy storage device via a connector 390, such as a USB connection 395, as shown in FIG. 5. Thus the smart module has a wide variety of use cases. Likewise, the enclosure 305 can comprises at least one of a battery charger 500, as shown in FIG. 5, an autonomous electronic device 600 in FIG. 6 and an internal component in an electronic device 700, as shown in the FIG. 7.

The smart module 300 and method 100 and features herein are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method to minimize standby loss, comprising:
detecting a current parameter at a load node;
determining whether a current parameter threshold has been reached; and
disabling power delivery based on determining whether the current parameter threshold has been reached.

2. The method of claim 1 wherein the detecting step includes at least one of periodically detecting a DC current value and periodically detecting a rate of change of a DC current value over time.

3. The method of claim 1 wherein when the detecting step includes periodically detecting a DC current value, the current parameter threshold is set at a predetermined DC current set-point, and when the detecting step includes periodically detecting a DC current value over time, the current parameter threshold is set at a predetermined rate of change of the DC current value over a certain time.

4. The method of claim 1 where the detecting step includes a value of change of current over time that may be realized by one or any of: fixed circuit elements, parameters set in memory, or parameters programmed by software commands.

5. The method of claim 1 further comprising providing an indicating component for visually indicating power delivery is disabled and that the current parameter threshold has been reached, the indicating component including a retracted position and an extended position.

6. The method of claim 1 further comprising providing a bypass switch configured to over ride certain operations of the method.

7. The method of claim 1 wherein the load node is coupled to an energy storage device.

8. The method of claim 1 wherein at least one of the detecting, determining and disabling steps is enabled by use of an integrated circuit.

9. The method of claim 1 wherein the steps of detecting, determining and disabling, define a battery charger with substantially zero standby loss once the current parameter threshold has been reached.

10. A module to minimize standby loss, comprising:
an enclosure;
an actuator; and
a current sensing circuit configured to detect a current parameter at a load node, determine whether a current parameter threshold has been reached and disable power delivery based on determining whether the current parameter threshold has been reached, by de-actuating the actuator.

11. The module of claim 10, wherein the current sensing circuit includes an activation circuit connected to the actuator to provide a signal to de-actuate the actuator.

12. The module of claim 10, wherein the actuator comprises a shape memory alloy configured to change shape through Joule heating.

13. The module of claim 10, wherein the actuator comprises a button including a retracted position and an extended position.

14. The module of claim 10, wherein the actuator includes at least one of: dissimilar metal mechanisms wherein two metals may contract differentially upon heating and produce a bending effect; electromagnetic mechanisms such that movement may be achieved through action of an electromagnet upon a magnetically soft material including at least one of solenoids, relays and motors; electrostatic mechanisms wherein a voltage is used to cause repulsion of like charges, resulting in separation and movement of one element relative to another; piezoelectric mechanisms wherein application of a voltage to materials having piezoelectric properties produce displacements which can be amplified mechanically or through including a screw drive; electroactive polymer mechanisms configured with materials that constrict with an application of a voltage; microelectromechanical system (MEMS) devices configured as miniature devices fabricated on silicon including electrostatic or electromechanical means to produce motion.

15. The module of claim 10, wherein the enclosure has an opening for receiving the actuator, the actuator comprising a button including a retracted position configured to enable the current sensing circuit and an extended position arranged to visually indicate that power delivery is disabled.

16. The module of claim 10, wherein the current parameter threshold is set at a predetermined DC current set-point, or is set at a predetermined rate of change of the DC current value over a certain time.

17. The module of claim 10 further comprising a bypass switch configured to over ride certain operations of the module.

18. The module of claim 10 wherein the load node is configured to be coupled to at least one of an electronic device, a wireless communication device and an energy storage device.

19. The module of claim 10 wherein the enclosure comprises at least one of a battery charger, an autonomous electronic device and an internal component in an electronic device.
